(19) United States
(12) Patent Application Publication
(10) Pub. No.: US 2020/0007685 A1
(43) Pub. Date: Jan. 2, 2020

(54) PRIORITIZATION OF ROUTING FOR ESCALATED COMMUNICATION SESSIONS IN A CONTACT CENTER

(71) Applicant: Avaya Inc., Santa Clara, CA (US)

(72) Inventors: Jibin George, Pune (IN); Salil Dhawan, Pune (IN); Sandeep Goynar, Pune (IN); Harsimran Jeet Singh, Pune (IN); Kalpana Autade, Pune (IN)

(21) Appl. No.: 16/021,586

(22) Filed: Jun. 28, 2018

(51) Int. Cl. H04M 3/523; H04M 3/51

(52) U.S. Cl. CPC H04M 3/5232; H04M 2201/60; H04M 3/5183; H04M 3/5133

(57) ABSTRACT

A plurality of escalated communication sessions are received. The plurality of escalated communication sessions are initially a plurality of established communication sessions between communication endpoints of users and communication endpoints of contact center agents. A priority for the plurality of escalated communication sessions is determined based on one or more routing factors. In response to determining the priority of the plurality of escalated communication sessions, the plurality of escalated communication sessions are routed to a communication endpoint of a supervisor or a technical specialist based on the priority.

### FIELD

The disclosure relates generally to contact centers and particularly to routing mechanisms for communication sessions in contact centers.

### BACKGROUND

Currently, contact centers with multiple escalated communication sessions from different contact center agents get routed to the same supervisor by using an escalation queue for the supervisor. At times, there may be multiple escalated communication sessions by different contact center agents directed to the same supervisor at approximately the same point in time (especially during periods of high call volume). The escalated communication sessions are then displayed to the supervisor. In current models, when multiple escalations are directed to the supervisor at the same time, the supervisor may select an escalation randomly or on a first-in-first-out basis. Currently, there are no other known mechanisms for managing escalated communication sessions.

### SUMMARY

These and other needs are addressed by the various embodiments and configurations of the present disclosure. A plurality of escalated communication sessions are received. The plurality of escalated communication sessions are initially a plurality of established communication sessions between communication endpoints of users and communication endpoints of contact center agents. A priority for the plurality of escalated communication sessions is determined based on one or more routing factors. In response to determining the priority of the plurality of escalated communication sessions, the plurality of escalated communication sessions are routed to a communication endpoint of a supervisor or a technical specialist based on the priority.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other SIP RFCs describing SIP are hereby incorporated by reference in their entirety for all that they teach.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for prioritizing routing of escalated communication sessions in a contact center.

FIG. 2 is a diagram that shows the flow of communication sessions in a contact center.

FIG. 3 is a diagram of a user interface for a supervisor/technical specialist to manage an escalation queue.

FIG. 4 is a flow diagram of a process for prioritizing routing of communication sessions to an escalation queue.

FIG. 5 is a flow diagram of a process for routing prioritized communication sessions from an escalation queue.

### DETAILED DESCRIPTION

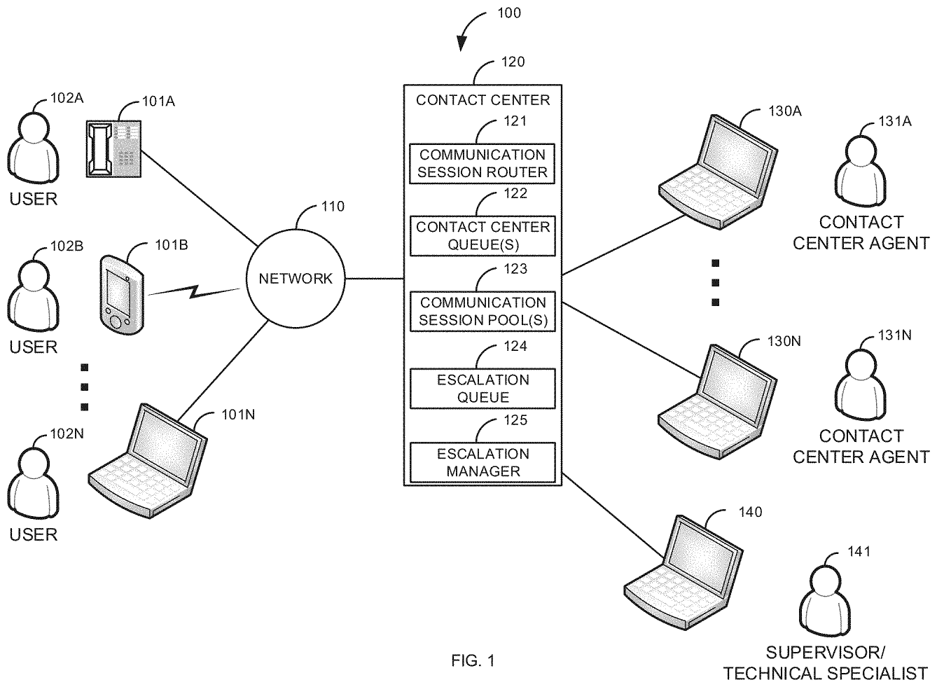

FIG. 1 is a block diagram of a first illustrative system 100 for prioritizing routing of escalated communication sessions in a contact center 120. The first illustrative system 100 comprises user communication endpoints 101A-101N, a network 110, a contact center 120, agent communication endpoints 130A-130N, and a supervisor/technical specialist communication endpoint 140. In addition, FIG. 1 shows users 101A-101N, contact center agents 131A-131N, and a supervisor/technical specialist 140.

The user communication endpoints 101A-101N can be or may include any user communication endpoint 101 device that can communicate on the network 110, such as a Personal Computer (PC), a telephone, a video system (e.g., a conference room video system), a cellular telephone, a Personal Digital Assistant (PDA), a tablet device, a notebook device, a smartphone, and/or the like. The user communication endpoints 101A-101N are devices where a communication sessions ends. The user communication endpoints 101A-101N are not network elements that facilitate and/or relay a communication session in the network 110, such as a communication manager or router. As shown in FIG. 1, any number of user communication endpoints 101A-101N may be connected to the network 110.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), and the like. Thus, the network 110 is an electronic communication network configured to carry messages via packets and/or circuit switched communications.

The contact center 120 can be or may include any hardware coupled with software that can manage and route communication sessions between the user communication endpoints 101A-101N and the agent communication endpoints 130A-130N/supervisor/technical specialist communication endpoint 140. The contact center 120 further comprises a communication session router 121, contact center queue(s) 122, communication session pool(s) 123, an escalation queue 124, and an escalation manger 125.

The communication session router 121 can be or may include any hardware coupled with software that can route communication sessions in the contact center 120, such as an Automatic Call Distributer (ACD), a Private Branch Exchange (PBX), a session manager, a communication manager, a switch, and/or the like. The communication session router 121 can route various kinds of communication sessions between the user communication endpoints 101A-101N, the agent communication endpoints 130A-130N and/or the supervisor/technical specialist communication endpoint 140, such as, voice communication sessions, video communication sessions, Instant Messaging (IM) communication sessions, chat communication sessions, virtual reality communication sessions, social media communication sessions, email communication sessions, text messaging communication sessions, and/or the like. The communication session router 121 may route both incoming communication sessions and outbound communication sessions.

The contact center queue(s) 122 can be or may include any known contact center queues 122. The contact center queue(s) 122 may work in various known manners, such as first-in-first-out and/or the like. The contact center queue(s) 122 may support defined groups of contact center agents 131A-131N. In one embodiment, the contact center 120 may not use contact center queue(s) 122. For example, the contact center 120 may use the communication session pool(s) 123 where the contact center agents 131A-131N can select individual communication sessions. In one embodiment, the contact center 120 may use both the contact center queue(s) 122 and the communication session pool 123.

The escalation queue 124 is a contact center queue 122 that is designed to handle escalated communication sessions that are currently being serviced by the contact center agents 131A-131N. The escalation queue 124 routes the escalated communication sessions to the supervisor/technical specialist communication endpoint 140. For example, a contact center agent 131 may escalate a voice communication session to the escalation queue 124 to be serviced by a supervisor/technical specialist 141. Although not shown, the contact center 120 may comprise multiple escalation queues 124. For example, the contact center 120 may have multiple supervisors/technical specialists 141 that each have an assigned escalation queue 124.

The escalation manager 125 can be or may include hardware coupled with software that can manage escalation of communication sessions from the contact center queue(s) 122/communication session pool(s) 123. The escalation manager 125 can manage how various communication sessions are routed to the supervisor/technical specialist communication endpoint 140.

The agent communication endpoints 130A-130N can be the same or similar to the user communication endpoints 101A-101N. The agent communication endpoints 130A-130N may comprise a plurality of agent communication endpoints 130A-130N. For example, the agent communication endpoints 130A-130N may comprise a telephone and a desktop computer for each contact center agent 131.

The supervisor/technical specialist communication endpoint 140 can be the same as or similar to the agent communication endpoint 130. Although not shown, the contact center 120 may have multiple supervisor/technical specialist communication endpoints 140. For example, the contact center 120 may have multiple supervisors 141 that support different escalation queues 124.

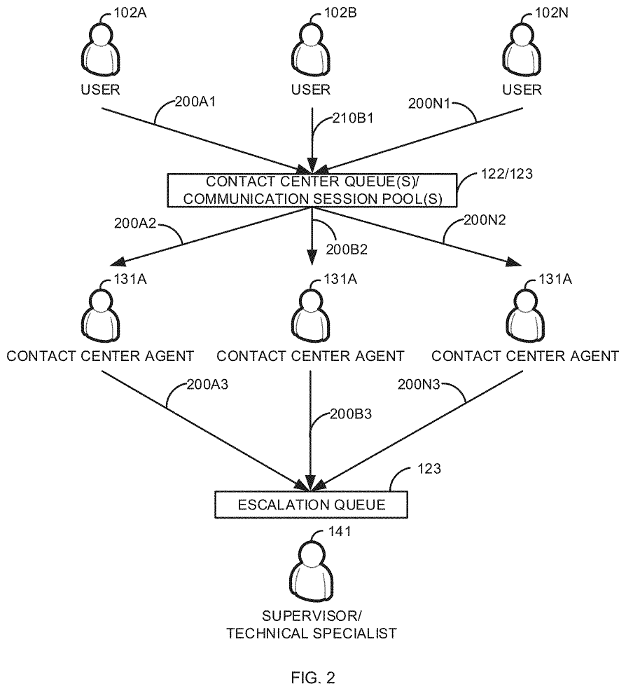

FIG. 2 is a diagram that shows the flow of communication sessions 200 in a contact center 120. The communication sessions 200A1-200N1 are established with the contact center 120. The communication sessions 200A1-200N1 can be initiated from the contact center 120 (e.g., an outbound call) or initiated to the contact center 120 (e.g., an inbound call). The communication sessions 200A1-200N1 may be various types of communication sessions 200, such as voice communication sessions 200, video communication sessions 200, Instant Messaging (IM) communication sessions 200, social media communication sessions 200, virtual reality communication sessions 200, text messaging communication sessions 200, and/or the like.

The communication sessions 200A1-200AN with the users 102A-102N are placed in the contact center queue(s) 122 or the communication session pool(s) 123. For example, a voice call 200 may be held in the contact center queue 122 while waiting to be serviced by a contact center agent 131 (e.g., music-on-hold). The communication sessions 200A1-200N1 progress from the contact center queue(s) 122 to the communication sessions 200A2-200N2 when connected to the contact center agents 131A-131N.

The communication sessions 200A2-200N2 are then escalated into the escalated communication sessions 200A3-200N3 and are placed into the escalation queue 124. For example, the contact center agent 131A may escalate the communication session 200A2 to the escalation queue 124 when the user 102A asks the contact center agent 131A to talk to the supervisor 141. When a communication session 200 is escalated, the process of escalating the communication session 200 from the escalation queue 124 to the supervisor/technical specialist 141 may be accomplished in various ways, such as, transferring the communication session 200 to the supervisor/technical specialist 141, conferencing the supervisor/technical specialist 141 into the communication session 200, where the supervisor/technical specialist 141 silently monitors the communication session 200, where the supervisor/technical specialist 141 is in a whisper mode (where the user 102 cannot hear what the supervisor/technical specialist 141 is saying to the contact center agent 131), where the supervisor/technical specialist 141 only views video of a communication session 200, where the supervisor/technical specialist 141 is provided a voice-to-text view of an audio communication session 200, and/or the like. The supervisor/technical specialist 141 then handles the escalated communication sessions 200A3-200N3.

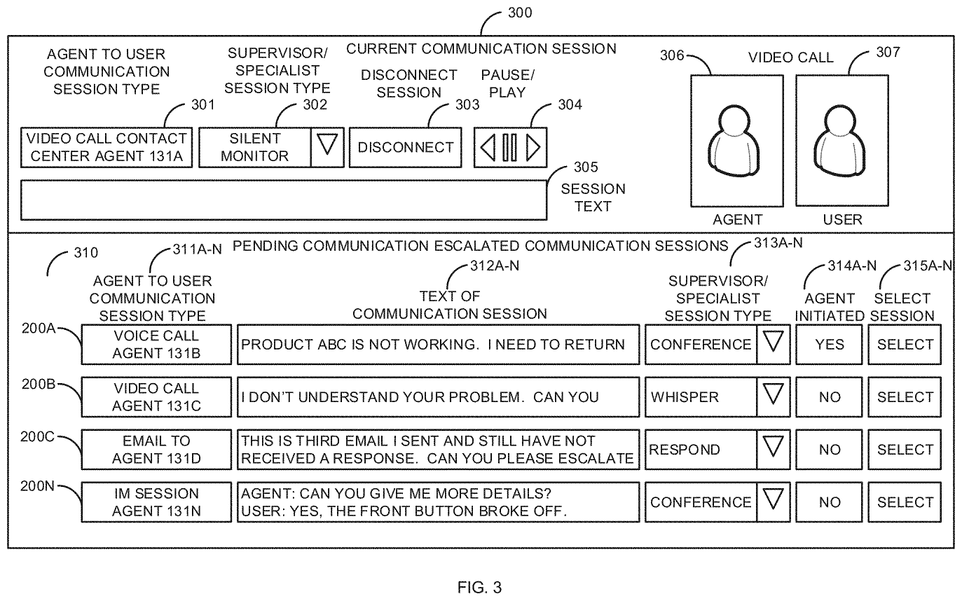

FIG. 3 is a diagram of a user interface 300 for a supervisor/technical specialist 141 to manage an escalation queue 124. The user interface 300 comprises an agent to user communication session type 301, a supervisor/technical specialist session type 302, a disconnect session button 303, pause/play buttons 304, a text of the communication session 305, a video view of an agent 306, a video view of a user 307, and a view of the pending escalated communication sessions 310.

The elements 301-307 are for an escalated communication session 200 that the supervisor/technical specialist 141 is currently handling. For example, the communication session 200A3 is placed into the escalation queue 124 and is then sent to the supervisor/technical specialist 141 and displayed by the elements 301-307.

In FIG. 3, the communication session 200 that the supervisor/technical specialist 141 is currently handling is a video call. The agent to user communication session type 301 indicates that the communication session 200 that the supervisor/technical specialist 141 is handling is a video call between the contact center agent 131A and a user 102. The supervisor/technical specialist session type 302 is set to silent monitor. Silent monitor indicates that the supervisor/technical specialist 141 is listening/viewing the video call where neither the contact center agent 131A nor the user 102 can hear or see the supervisor/technical specialist 141. The supervisor/technical specialist 141 may change the supervisor/technical specialist session type 302 dynamically. For example, the supervisor/technical specialist 141 may change the silent monitoring to conference and join the communication session 200. By changing to conference mode, the supervisor/technical specialist can join the video call and talk with contact center agent 131A and the user 102.

The supervisor/technical specialist 141 can select the disconnect session button 303 to disconnect from the communication session 200. For example, if the supervisor/technical specialist 141 selected the disconnect session button 303, the supervisor/technical specialist 141 would no longer be silently monitoring the video communication session 200 between the contact center agent 131A and the user 102. Once the supervisor/technical specialist 141 selects the disconnect session button 303, the supervisor/technical specialist 141 is then connected to the communication session 200A, which is currently at the top of the escalation queue 124 (or may be asked if the supervisor/technical specialist 141 wants to be connected to the communication session 200A).

The supervisor/technical specialist 141 may also pause/play the communication session 200 that the supervisor/technical specialist 141 is currently monitoring. For example, if the supervisor/technical specialist 141 is interrupted for some reason, the supervisor/technical specialist 141 can select the pause/play button to pause the communication session 200. When the supervisor/technical specialist 141 selects the pause/play button (pause in this instance) the video communication session 200 between the contact center agent 131A and the user 102 is still live and continues. However, the video call is recorded so that the supervisor/technical specialist 141 can then select the pause/play button 304 (play in this instance) to continue to listen to the communication session 200. The supervisor/technical specialist 141 may also move the communication back/forward using the pause/play button 304.

The text of the communication session 305 displays text of the communication session 200. In FIG. 3, the communication session 200 is a video call and the supervisor/technical specialist 141 is listening to the video call, which is why the text of the communication session 305 is blank. If the communication session 200 included text (e.g., an IM session or where the audio is converted to text) the text of the communication session 305 would include text of the communication session 200.

Since the communication session 200 is a video call, the video view of an agent 306 and the video view of a user 307 are displayed to the supervisor/technical specialist 141. If the communication session 200 was an audio or text based communication session 200 (e.g., social media), the video view of an agent 306 and the video view of a user 307 would not be shown (or would be empty) to the supervisor/technical specialist 141.

The view of the pending escalated communication sessions 310 shows the communication sessions 200A-200N that are currently in the escalation queue 124. A communication session 200 may be escalated to the escalation queue 124 based on various routing factors, such as, a user priority (e.g., if the user 102 is a gold customer), a communication session duration, a number of past communication sessions 200 on the same ticket, a waiting time of a communication session 200, a number of hops (e.g., transfers between contact center agents 131/supervisors/technical specialists 141), a contact center agent skill, an contact center agent 131 selection, administered preferences, keywords spoken in the communication session 200, and/or the like.

The communication sessions 200A-200N are shown to the supervisor/technical specialist 141 using agent to user communication session types 311A-311N, text of the communication sessions 312A-312N, supervisor/technical specialist session types 313A-313N, agent initiated indicators 314A-314N, and select session buttons 315A-315N.

The agent to user communication session types 311A-311N identify the type of communication sessions 200A-200N that are in the escalation queue 124. The communication session 200A is a voice call that includes the contact center agent 131B. The communication session 200B is a video call that includes the contact center agent 131C. The communication session 200C is an email that contact center agent 131D is working on. The communication session 200N is an Instant Messaging (IM) communication session 200N that the contact center agent 131N is communicating in.

The text of the communication sessions 312A-312N show text of the communication session sessions 200A-200N in the escalation queue 124. The text of the communication session 312A-312B show text (audio converted to text) of the voice call 200A and the video call 200B. The text of the communication session 312C-312N show the actual text of the communication sessions 200C-200N (i.e., text of the email 313C and text of the IM session 312N).

The supervisor/technical specialist session types 313A-313N show the currently selected method for the supervisor/technical specialist 141 to join the escalated communication sessions 200A-200N. The supervisor/technical specialist session type 313A shows that the supervisor/technical specialist 141 will join the communication session 200A by conferencing into the communication session 200A. The supervisor/technical specialist session type 313B shows that the supervisor/technical specialist 141 will join the communication session 200B by using a whisper mode. The supervisor/technical specialist session type 313C shows that the supervisor/technical specialist 141 will join the communication session 200C by responding to the email of the user 102. The supervisor/technical specialist session type 313N shows that the supervisor/technical specialist 141 will join the communication session 200N by conferencing into the IM communication session 200N. As shown in FIG. 3, the supervisor/technical specialist 141 may dynamically change the supervisor/technical specialist session type 313A-313N. For example, the supervisor/technical specialist 141 may change the supervisor/technical specialist session type 313A to silent monitoring before being connected to the communication session 200A.

The supervisor/technical specialist session type 313A-313N may be automatically selected by the escalation manager 125. The supervisor/technical specialist session type 313A-313N may be automatically selected based on various factors, such as, a user priority (e.g., if the user 102 is a gold customer), a communication session duration, a number of past communication sessions 200 on the same ticket, a waiting time of a communication session 200, a number of hops (e.g., transfers between contact center agents 131), a contact center agent skill level, an contact center agent 131 selection, a preference of the supervisor/technical specialist 141, a load factor (e.g., how many communication sessions 200 are in the escalation queue 124/contact center queue(s) 122), keywords detected in the communication session 200 (e.g., “I don't understand”), and/or the like.

The agent initiated indicators 314A-314N show whether the communication sessions 200A-200N have been escalated by a contact center agent 131. As shown in FIG. 3, the communication session 200A has been initiated by the contact center agent 131B as indicated by the agent initiated indicator 314A. The agent indicators 314B-314N show that the communication sessions 200B-200N were not initiated by a contact center agent 131 but have been automatically escalated to the escalation queue 124 by the escalation manager 125.

The select session buttons 315A-315N allow the supervisor/technical specialist 141 to select any of the communication sessions 200A-200N in the escalation queue 124. For example, the supervisor/technical specialist 141 may select the select session button 315N to conference into the IM communication session 200N. This allows the supervisor/technical specialist to override the priority of the escalation queue 124.

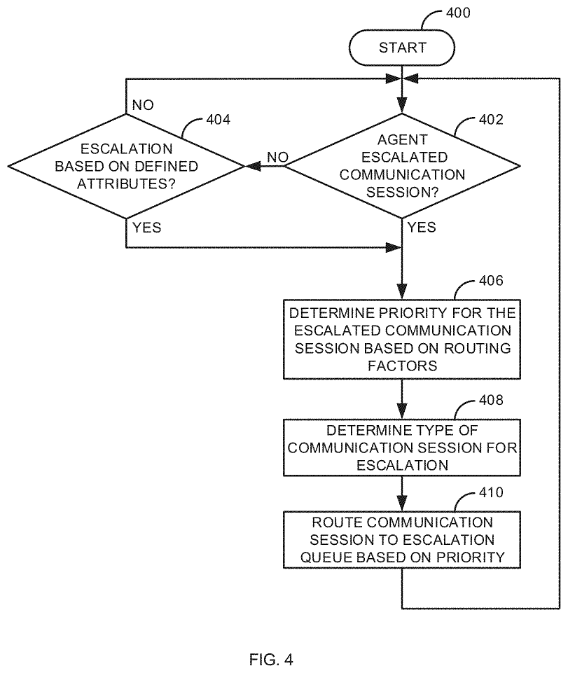

FIG. 4 is a flow diagram of a process for prioritizing routing of communication sessions 200 to an escalation queue 124. Illustratively, the user communication endpoints 101A-101N, the contact center 120, the communication session router 121, the contact center queue(s) 122, the communication session pool(s) 123, the escalation queue 124, the escalation manager 125, the agent communication endpoints 130A-130N, and the supervisor/technical specialist communication endpoint 140 are stored-program-controlled entities, such as a computer or microprocessor, which performs the method of FIGS. 2-5 and the processes described herein by executing program instructions stored in a computer readable storage medium, such as a memory (i.e., a computer memory, a hard disk, and/or the like). Although the methods described in FIGS. 2-5 are shown in a specific order, one of skill in the art would recognize that the steps in FIGS. 2-5 may be implemented in different orders and/or be implemented in a multi-threaded environment. Moreover, various steps may be omitted or added based on implementation.

The process starts in step 400. The escalation manager 125 determines, in step 402, if a communication session 200 has been escalated by a contact center agent 131. If a communication session 200 has not been escalated by a contact center agent 131 in step 402, the escalation manager 125 determines, in step 404, if a communication session 200 needs to be escalated based on defined attributes (e.g., routing factors). For example, if the contact center agent 131 and/or user 102 are using profanity in the communication session 200 the communication session 200 may be automatically escalated to the escalation queue 124. If a communication session 200 has not been escalated in step 404, the process goes back to step 402.

Otherwise, if a contact center agent 131 escalated a communication session 200 (step 402) or if the communication session 200 was automatically escalated (step 404), the escalation manager 125 determines, in step 406, a priority for the escalated communication session 200. For example, the communication sessions 200A-200B are placed higher in the escalation queue 124 because they are real-time communication sessions 200A-200B that have been transferred between multiple contact center agents 131 without being resolved. Alternatively, the communication session 200C may receive a higher priority over the communication sessions 200A-200B because the contact center agent 131D has not been able to resolve the user's problem after two days. In one embodiment, the priority can be based on the type of communication session 200. For example, real-time communication sessions 200A, 200B, and 200N may receive a higher priority in step 406 versus non-real-time communication sessions (e.g., email communication session 200C).

The communication manager 125 may use an algorithm that calculates a percentage based on rules. For example, the percentage may be based on the customer (e.g., a gold/silver customer), a time that the communication session 200 waited on hold, keywords in the communication session 200, etc. How the communication sessions 200 are placed into the escalation queue 124 is based on the calculated percentage. For example, if a new communication session 200 had a higher calculation number (e.g. 0.95 on a scale of 0 to 1) than the communication sessions 200A-200N (below 0.95), the new communication session 200 would be placed at the top of the escalation queue 124.

The escalation manger 125 determines, in step 408, the escalation type for the communication session 200 (e.g., as shown in 302/313A-313N). For example, the determined escalation type for the communication session 200 may be silent monitoring based on a first time period of a call and conference based on a second time period (a longer time period) of the same call. The communication session 200 is then routed, in step 410, to the escalation queue 124 based on the determined priority of step 406. The process then goes back to step 402.

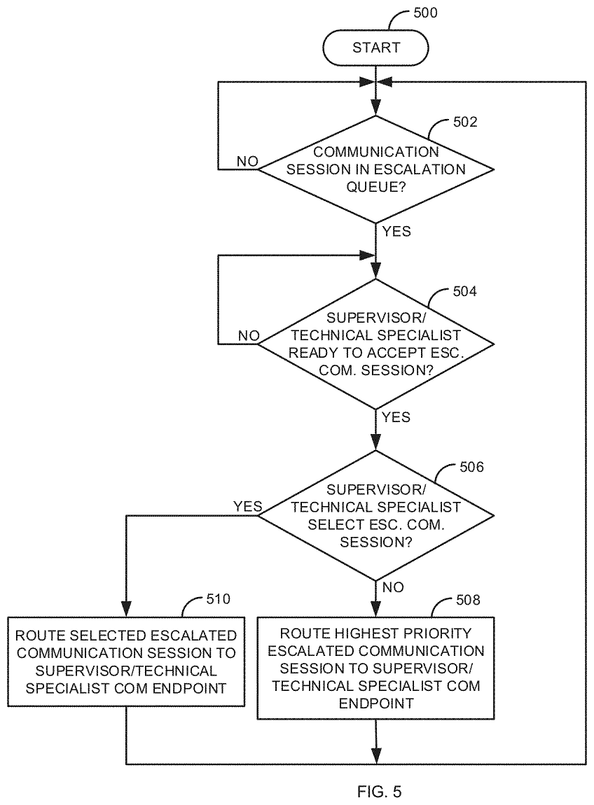

FIG. 5 is a flow diagram of a process for routing prioritized escalated communication sessions 200 from an escalation queue 124. The process starts in step 500. The escalation manager 125 determines, in step 502, if a communication session 200 is in the escalation queue 124. If a communication session 200 is not in the escalation queue 124 in step 502, the process of step 502 repeats.

If a new communication session 200 is in the escalation queue 124 (routed to the escalation queue 124 in step 410) in step 502, the escalation manager 125 determines, in step 504, if the supervisor/technical specialist 414 is ready to accept a communication session 200. For example, the supervisor/technical specialist 141 may have selected a non-availability status or has not logged in. If the supervisor/technical specialist 141 is not ready to accept a communication 200 in step 504, the process of step 504 repeats.

If the supervisor/technical specialist 141 is ready to accept a communication session 200 in step 504, the escalation manager 125 determines, in step 506, if the supervisor/technical specialist 141 has selected a specific escalated communication session 200 (e.g., by selecting one of the select session buttons 315A-315N). If the supervisor/technical specialist has selected a specific communication session 200 in step 506, the selected communication session 200 is routed, in step 510, by the communication session router 121 to the supervisor/technical specialist communication endpoint 140 and the process goes back to step 502. Otherwise, if the supervisor/technical specialist 141 has not selected a specific escalated communication session 200 in step 506, the communication session router 121 routes, in step 508, the highest priority escalated communication session 200 to the supervisor/technical specialist 141 communication endpoint 140 (e.g., the communication session 200A). The process then goes to step 502.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network 110, such as a LAN and/or the Internet, or within a dedicated system. Thus, it should be appreciated, that the components of the system can be combined in to one or more devices or collocated on a particular node of a distributed network 110, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system comprising:
a microprocessor; and
a non-transitory computer readable medium, coupled with the microprocessor and comprising microprocessor readable and executable instructions that program the microprocessor to:
receive a plurality of escalated communication sessions, wherein the plurality of escalated communication sessions are initially a plurality of established communication sessions between communication endpoints of users and communication endpoints of human contact center agents;
determine a priority for each of the plurality of escalated communication sessions based on one or more routing factors associated with each escalated communication session; and
in response to determining the priority of the plurality of escalated communication sessions, route the plurality of escalated communication sessions to an escalation queue on a communication endpoint of a supervisor or a technical specialist, wherein each of the plurality of escalated communication sessions are routed to the escalation queue based on the determined priority for each of the plurality of escalated communication sessions.

2. The system of claim 1, wherein routing the plurality of escalated communication sessions comprises automatically changing a communication session type to at least one of: a communication session transfer; a conference communication session; a silent monitoring of a voice communication session, a video communication session, an instant messaging communication session, or virtual reality communication session; a whisper mode; a video-only view of the video communication session; and a text view of the voice communication session, the video communication session, or the virtual reality communication session.

3. The system of claim 2, wherein the changed communication session type is automatically determined based on the one or more routing factors.

4. The system of claim 1, wherein a view of the escalation queue is displayed on the communication endpoint of the supervisor or the technical specialist.

5. The system of claim 4, wherein the supervisor or technical specialist selects an individual one of the escalated communication sessions in the displayed view of the escalation queue to initiate routing of the selected escalated communication session.

6. The system of claim 4, wherein the plurality of escalated communication sessions are voice communication sessions and wherein the displayed view of the escalation queue comprises a live voice to text view of the plurality of escalated communication sessions.

7. The system of claim 4, wherein the priority of the escalated communication sessions placed in the escalation queue dynamically changes in the displayed view of the escalation queue based on a new communication session being escalated.

8. The system of claim 4, wherein the plurality of escalated communication sessions placed in the escalation queue comprise at least two of a voice communication session, a video communication session, an instant messaging communication session, a virtual reality communication session, a text messaging communication session, an email communication session, and a social media communication session.

9. The system of claim 1, wherein a first established escalated communication session of the plurality of escalated communication sessions is routed to the communication endpoint of the supervisor or technical specialist, wherein routing the first established escalated communication session causes the communication endpoint of the supervisor or technical specialist to be joined into the first established escalated communication session, wherein the first established escalated communication session is a voice or video communication session, and wherein the supervisor or technical specialist pauses presented voice/video content received from the first established escalated communication session while the first established escalated communication session remains a live communication session.

10. The system of claim 1, wherein the one or more routing factors comprise at least one of: a user priority, a communication session duration, a number of past communication sessions on the same ticket, a waiting time of a communication session, a number of hops, a spoken keyword, and an agent skill.

11. A method comprising:
receiving a plurality of escalated communication sessions, wherein the plurality of escalated communication sessions are initially a plurality of established communication sessions between communication endpoints of users and communication endpoints of human contact center agents;
determining a priority for each of the plurality of escalated communication sessions based on one or more routing factors associated with each escalated communication session; and
in response to determining the priority of the plurality of escalated communication sessions, routing the plurality of escalated communication sessions to an escalation queue on a communication endpoint of a supervisor or a technical specialist, wherein each of the plurality of escalated communication sessions are routed to the escalation queue based on the determined priority for each of the plurality of escalated communication sessions.

12. The method of claim 11, wherein routing the plurality of escalated communication sessions comprises automatically changing a communication session type to at least one of: a communication session transfer; a conference communication session; a silent monitoring of a voice communication session, a video communication session, an instant messaging communication session, or virtual reality communication session; a whisper mode; a video-only view of the video communication session; and a text view of the voice communication session, the video communication session, or the virtual reality communication session.

13. The method of claim 12, wherein the changed communication session type is automatically determined based on the one or more routing factors.

14. The method of claim 11, wherein a view of the escalation queue is displayed on the communication endpoint of the supervisor or the technical specialist.

15. The method of claim 14, wherein the supervisor or technical specialist selects an individual one of the escalated communication sessions in the displayed view of the escalation queue to initiate routing of the selected escalated communication session.

16. The method of claim 14, wherein the plurality of escalated communication sessions are voice communication sessions and wherein the displayed view of the escalation queue comprises a live voice to text view of the plurality of escalated communication sessions.

17. The method of claim 14, wherein the priority of the escalated communication sessions placed in the escalation queue dynamically changes in the displayed view of the escalation queue based on a new communication session being escalated.

18. The method of claim 14, wherein the plurality of escalated communication sessions placed in the escalation queue comprise at least two of a voice communication session, a video communication session, an instant messaging communication session, a virtual reality communication session, a text messaging communication session, an email communication session, and a social media communication session.

19. The method of claim 11, wherein a first established escalated communication session of the plurality of escalated communication sessions is routed to the communication endpoint of the supervisor or technical specialist, wherein routing the first established escalated communication session causes the communication endpoint of the supervisor or technical specialist to be joined into the first established escalated communication session, wherein the first established escalated communication session is a voice or video communication session, and wherein the supervisor or technical specialist pauses presented voice/video content received from the first established escalated communication session while the first established escalated communication session remains a live communication session.

20. The method of claim 11, wherein the one or more routing factors comprise at least one of: a user priority, a communication session duration, a number of past communication sessions on the same ticket, a waiting time of a communication session, a number of hops, a spoken keyword, and an agent skill.
